(19) United States
(12) Patent Application Publication
(10) Pub. No.: US 2018/0224024 A1
(43) Pub. Date: Aug. 9, 2018

(54) TUBE POSITIONING DEVICE

(71) Applicant: Eric Scott, Fallon, NV (US)

(72) Inventor: Eric Scott, Fallon, NV (US)

(21) Appl. No.: 15/892,588

(22) Filed: Feb. 9, 2018

Related U.S. Application Data
(60) Provisional application No. 62/456,708, filed on Feb. 9, 2017.

(51) Int. Cl. F16L 1/10; B25J 1/02; B25G 3/02; B25G 1/10

(52) U.S. Cl. CPC F16L 1/10; B25G 1/102; B25G 3/02; B25J 1/02

(57) ABSTRACT

The present invention provides a tube positioning device for setting a tube within a narrow passageway. The tube positioning device includes a flexible elongated member that removably secures to a handle and a fitting member. The elongated member includes a first end and a second end, wherein each the first end and the second include a fastener. The handle includes a gripping member perpendicularly affixed to a connection member, wherein the connection member includes a fastener on a first end that removably secures to the first end of the elongated member. The fitting member includes a pair of fasteners disposed on opposing ends thereof, wherein a first fastener removably secures to the second end of the elongated member and a second fastener removably secures to a tube.

### CROSS REFERENCE TO RELATED APPLICATION

This application claims the benefit of U.S. Provisional Application No. 62/456,708 filed on Feb. 9, 2017. The above identified patent application is herein incorporated by reference in its entirety to provide continuity of disclosure.

### BACKGROUND OF THE INVENTION

The present invention relates to tube placement devices. More specifically, the present invention provides a tube positioning device for setting various tubes, such as, hydraulic tubes, within narrow passageways.

Installing hoses or various types of hydraulic tubes is often a two person job that can be very time consuming and tedious. This is especially true when attempting to route hoses through areas with limited space or access. In many instances, a user may risk injury and spend a good deal of time trying to feed hoses through narrow openings with limited success. Additionally, some hoses and tubes may be susceptible to contamination or damage if a user repeatedly touches the housing of the hose during installation. To address these concerns, the present invention provides a tube positioning device for setting hydraulic tubes within a narrow passageway on an object or structure. Although the device is contemplated for use with hydraulic tubes, the device may be used for setting any type of tube within a narrow opening.

Devices have been disclosed in the known art that relate to tube and wire placement devices. These include devices that have been patented and published in patent application publications. These devices generally relate to devices for setting wires within tubes or various openings. One device includes an apparatus that comprises a draw wire having an aperture at a distal end for drawing a piece of wire within a narrow tube. Another device includes an apparatus used to insert an electrical conductor in conduit by using a self propelled projectile. Another device utilizes an apparatus to guide a threadlike element into a duct or sleeve by exerting a thrust effort. Another device inserts an instrument through a narrow inlet passage and thereafter positions the instrument at a predetermined location utilizing a spring and catch mechanism. Lastly, one device utilizes a series of hooks and loops to draw electrical wires through a conduit of an electrical connection box.

These known art devices have several known drawbacks. Many of these devices lack a flexible elongated member having removably securable fasteners configured to receive various fittings on a first end and a handle on a second end thereof. Further, these devices fail to include interchangeable elongated members used to increase or decrease the length of the device. Lastly, these devices fail to include a plastic coated elongated member, wherein the coating prevents the flexible elongated member from becoming lodged within a narrow passage way.

In light of the devices disclosed in the known art, it is submitted that the present invention substantially diverges in design elements from the known art and consequently it is clear that there is a need in the art for an improvement to existing devices. In this regard the instant invention substantially fulfills these needs.

### SUMMARY OF THE INVENTION

In view of the foregoing disadvantages inherent in the known types of tube placement devices now present in the known art, the present invention provides a new tube positioning device wherein the same can be utilized for providing convenience for the user when placing hydraulic tubes within a narrow passageway.

It is therefore an object of the present invention to provide a new and improved tube positioning device that has all of the advantages of the known art and none of the disadvantages.

It is another object of the present invention to provide a tube positioning device, comprising a flexible elongated member having a first end and a second end, wherein each the first end and the second include a fastener; a handle having a gripping member secured to a connection member, wherein the connection member includes a fastener on a first end thereof, wherein the connection member is configured to removably secure to the first end of the elongated member; and a fitting member including a pair of fasteners on opposing ends thereof, wherein a first fastener removably secures to the second end of the elongated member and a second fastener is configured to removably secure to a tube.

Another object of the present invention is to provide a tube positioning device, wherein the elongated member comprises a plurality of wires surrounded by an outer layer of flexible material.

Yet another object of the present invention is to provide a tube positioning device wherein the gripping member of the handle comprises a cylindrical shape that is perpendicularly disposed in relation to the connection member.

Another object of the present invention is to provide a tube positioning device that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the tube positioning device in a detached configuration.

FIGS. 2A, 2B, and 2C shows perspective views of embodiments of the elongated member, wherein each embodiment has a different length.

FIG. 3 shows a cross sectional view of an embodiment of the elongated member.

FIG. 4 shows a perspective view of an embodiment of the tube positioning device, wherein a hydraulic tube is being pulled through a narrow passageway.

### DETAILED DESCRIPTION OF THE INVENTION

Reference is made herein to the attached drawings. Like reference numerals are used throughout the drawings to depict like or similar elements of the tube positioning device. For the purposes of presenting a brief and clear description of the present invention, the preferred embodiment will be discussed as used for positioning a hydraulic tube within a narrow passageway. The figures are intended for representative purposes only and should not be considered to be limiting in any respect.

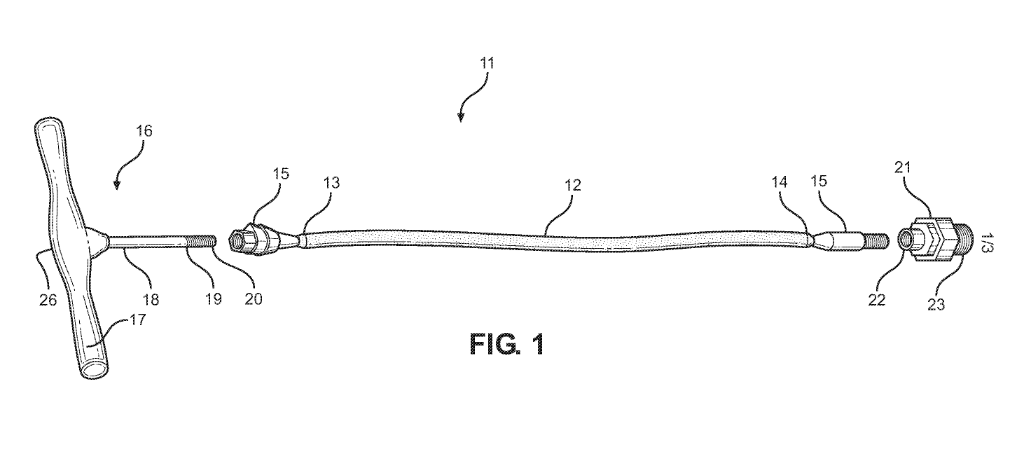

Referring now to FIG. 1, there is shown a perspective view of an embodiment of the tube positioning device in a detached configuration. A tube positioning device 11 is provided. The tube positioning device 11 comprises a handle 16, an elongated member 12, and a fitting member 21 that are removably securable to each other. The elongated member 12 includes a first end 13 and a second end 14, wherein each the first end 13 and the second 14 include a fastener 15 thereon. In the illustrated embodiment, the fastener 15 on the first end 13 comprises a female threaded connection and the fastener 15 on the second end 14 comprises a male threaded connection. However, in alternative embodiments any suitable fastener may be used. In a preferred embodiment, the female threaded connection and the male threaded connection are comprised of steel and include a ¼ by twenty thread per inch connection. However, any suitable material and connection may be used. The elongated member 12 is constructed of a flexible material, such as, braided steel. The flexible material allows the elongated member 12 to be positioned within a passageway having bends, wherein the elongated member 12 can be fed therethrough. The elongated member 12 further includes an outer layer of flexible material, such as a plastic coating, in order to prevent the braided steel from becoming stuck within the passageway during use.

The handle 16 comprises a gripping member 17 that is affixed to a connection member 18, wherein the connection member 18 includes a fastener 20 on a first end 19 thereof. The connection member 18 is configured to removably secure to the first end 13 of the elongated member 12 via the fasteners 15, 20. In the illustrated embodiment, the fastener 20 on the first end 19 of the connection member 18 comprises a threaded male connection, configured to secure to the female threaded connection on the fastener 15 of the first end 13 of the elongated member 12. However, the first end 19 of the connection member 18 may have any suitable fastener 20 thereon.

In the illustrated embodiment, the gripping member 17 comprises a cylindrical shape wherein the gripping member includes an arcuate surface 26. The arcuate surface 26 is configured to receive a palm of a hand of a user. In this way, the arcuate surface 26 is configured to rest flush with the curve of the palm, such that it provides a comfortable grip for the user. In alternative embodiments, the gripping member 17 may comprise any alternative configuration capable of being grasped, such as, a semi-circular shape with an aperture therein. In the illustrated embodiment, the connection member 18 comprises a cylindrical shape that is perpendicularly affixed to the gripping member 17 forming a T shaped handle 16. In alternative embodiments, the connection member 18 may comprise any suitable shape.

The fitting member 21 includes a pair of fasteners 22, 23 affixed on opposing ends thereof, wherein a first fastener 22 removably secures to the fastener 15 on the second end 14 of the elongated member and a second fastener 23 is configured to removably secure to a tube, such as a hydraulic tube. In the illustrated embodiment, the first fastener 22 comprises a female threaded connection that receives the male threaded connection of the fastener 15 on the second end 14 of the elongated member 12. The second fastener 23 comprises a male threaded connection configured to removable secure a tube. In a preferred embodiment, the tube is a hydraulic tube having a female connection on the receiving end thereof. In alternative embodiments, the fitting member 21 may include fasteners 23 of various sizes to allow for any type of tube to be secured to the fitting member 21. In this way, multiple fitting members 21 may be interchanged on the elongated member 12 depending on what type and size of tube is being positioned with the device 12. In the illustrated embodiment, the fitting member 21 further includes a central portion having a plurality of sides disposed in a hexagonal shape around an outer surface thereof. The hexagonal shape is configured to receive the inner surface of a wrench, such that the fitting member may be removably secured to a tube or the elongated member 12.

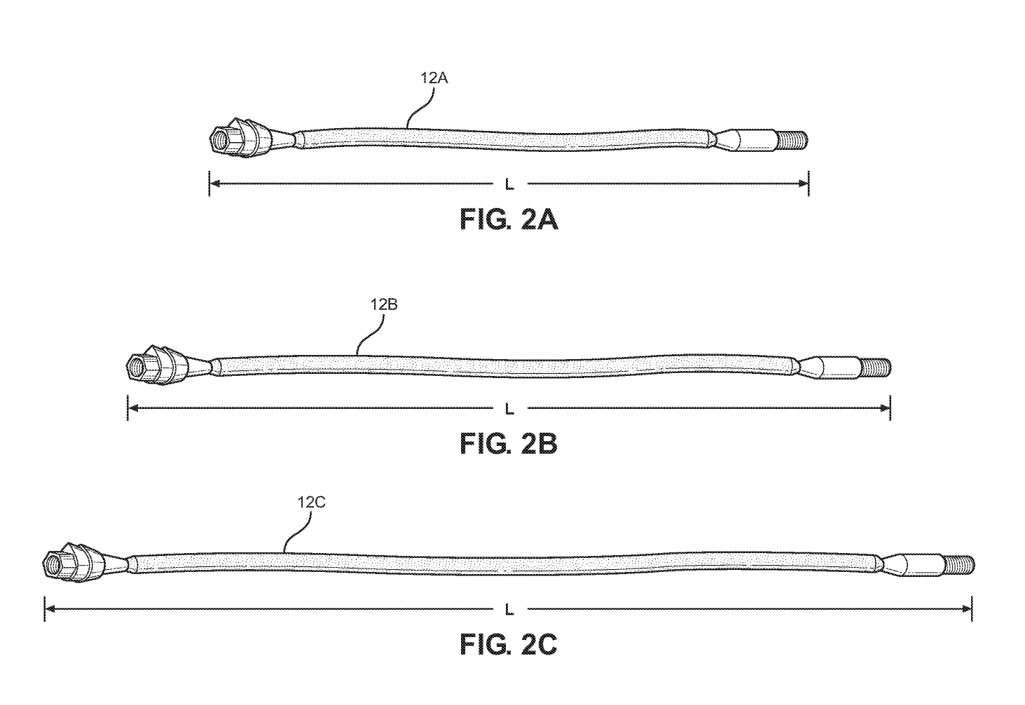

Referring now to FIGS. 2A, 2B, and 2C, there are shown perspective views of embodiments of the elongated member, wherein each embodiment has a different length. In the illustrated embodiments, the elongated member 12A, 12B, 12C may comprise various lengths L. Each length L may be used for positioning the elongated member through varying length passageways. In this way, a shorter passageway may only require a shorter length L elongated member 12, while a longer passageway may require a longer length elongated member 12 in order to set a tube in position. In a preferred embodiment, the tube positioning device includes three different length L elongated members 12A, 12B, 12C at five, ten, and fifteen feet, respectively. However, in alternative embodiments any suitable length L elongated member 12 may be used.

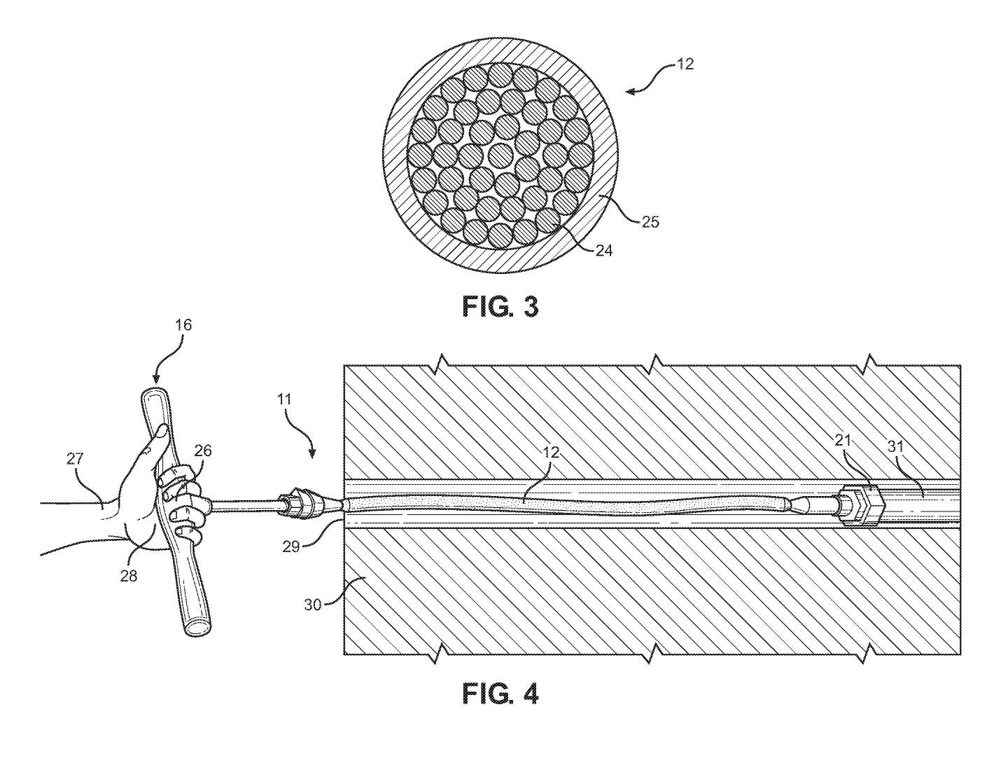

Referring now to FIG. 3, there is shown a cross sectional view of an embodiment of the elongated member. In the illustrated embodiment, the elongated member 12 comprises a plurality of wire members 24 that extend the length thereof. In a preferred embodiment, the plurality of wire members 24 comprise a braided pattern to increase the tensile strength of the elongated member 12 while still allowing the elongated member 12 to maintain flexibility. The elongated member 12 further comprises an outer layer 25 that surrounds the plurality of wire members 24. This outer layer is constructed of a flexible material, such as plastic, that is configured to prevent the plurality of wire members from becoming stuck when feeding the elongated member 12 through a passageway during use.

Referring now to FIG. 4, there is shown a perspective view of an embodiment of the tube positioning device, wherein a hydraulic tube is being pulled through a narrow passageway. In the illustrated embodiment, the tube positioning device 11 is utilized to removably secure to a tube 31 in order to set the tube 31 in place within a narrow passageway 29 of a structure 30. The device 11 is contemplated to be used for setting hydraulic tubes in place within a machine or any type of structure. In use, a user 27 feeds the elongated member 12 through a passageway 29 having two opposing open ends, such that the user 27 can access both ends of the elongated member 12. Once the elongated member 12 is in place, the user 27 selects an appropriately sized fitting member 21 that attaches to the tube 31 and removably secures the fitting member 21 and tube 31 to the second end of the elongated member 12. Once attached, the user 27 secures the handle 16 to the first end of the elongated member 12. Once secured, the user 27 can grasp and pull on the handle 16 to drag the tube 31 through the passageway 29 in order to set the tube in place. In use, the arcuate curve 26 of the handle 16 rests flush with the palm 28 of the user's hand to provide a comfortable gripping surface.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A tube positioning device, comprising:
an elongated member having a first end and a second end, wherein each the first end and the second include a fastener;
a handle having a gripping member secured to a connection member, wherein the connection member includes a fastener on a first end thereof, wherein the connection member is configured to removably secure to the first end of the elongated member; and
a fitting member including a pair of fasteners on opposing ends thereof, wherein a first fastener removably secures to the second end of the elongated member and a second fastener is configured to removably secure to a tube.

2) The tube positioning device of claim 1, wherein the elongated member is constructed of a flexible material.

3) The tube positioning device of claim 2, wherein the elongated member comprises a plurality of wires members.

4) The tube positioning device of claim 3, wherein the elongated member includes an outer layer surrounding the plurality of wire members.

5) The tube positioning device of claim 4, wherein the outer layer is a flexible material.

6) The tube positioning device of claim 1, wherein the fastener on the first end of the elongated member is a threaded female connection and the fastener on the second end of the elongated member is a threaded male connection.

7) The tube positioning device of claim 1, wherein the gripping member of the handle comprises a cylindrical shape that is perpendicularly disposed in relation to the connection member.

8) The tube positioning device of claim 1, wherein the gripping member of the handle includes an arcuate surface configured to receive a palm of a hand.

9) The tube positioning device of claim 1, wherein the first fastener of the fitting member is a female threaded connection and the second fastener of the fitting is a male threaded connection.

10) The tube positioning device of claim 1, wherein the fastener of the connection member is a male threaded member.

11) The tube positioning device of claim 1, wherein a central portion of the fitting member includes a plurality of sides disposed in a hexagonal shape therearound.
